(19) United States
(12) Patent Application Publication
(10) Pub. No.: US 2002/0171718 A1
(43) Pub. Date: Nov. 21, 2002

(54) Liquid refiller

(76) Inventor: Sung Joon Park, Inchon (KR)

Correspondence Address: BRINKS HOFER GILSON & LIONE, P.O. Box 10395, Chicago, IL, 60610, US

(21) Appl. No.: 09/861,089

(22) Filed: May 18, 2001

(51) Int. Cl. B41J 2/175

(52) U.S. Cl. 347/85

(57) ABSTRACT

The present invention provides a liquid refiller for filling liquid in a container. The refiller is comprised of a first mechanism for injecting the liquid into the container and a second mechanism for releasing from the container air compressed resulting from injecting the liquid into the container. The first mechanism may include a case and an injection piston movable inside the case. The second mechanism may include the injection piston and a suction piston movable inside the injection piston. The injection piston may be urged by a first urging member in such a direction as to move for injecting the liquid into the container. The refiller may also include a first locking mechanism for holding the injection piston against the urging force of the first urging member. The suction piston may be urged by a second urging member in such a direction as to move for suctioning the compressed air from the container. The refiller may also include a second locking mechanism for holding the suction piston against the urging force of the second urging member. When the liquid injection is completed, the second locking mechanism is automatically released to allow the suction piston to move by means of the second urging member in order to suction the compressed air from the container.

### BACKGROUND OF THE INVENTION

The present invention relates to a liquid refiller that refills an empty container and particularly to an ink refiller that automatically refills an empty printer ink cartridge and decompresses the compressed air inside the cartridge created by the refilling process.

Almost all of the businesses use a computer these days. It can be safely said that these businesses could not carry out their operations without a computer. As computers have become a prevalent business tool, so have printers along with computers. In fact, printers are output devices indispensable for virtually all tasks that a computer can perform. As printers have become a prevalent business tool, ink demand has increased considerably. Printers usually have a replaceable ink cartridge. When ink runs out, the old ink cartridge is replaced with a new ink cartridge. Replacing an ink cartridge is a very simple and clean operation and saves users' time. But this time saving comes with a high price. An ink cartridge usually costs as expensive as $30 to $40. In deed, cartridge replacement costs could become a financial burden on heavy printer users.

For those who do not want to spend much for replacing ink cartridges, there are ink refilling products available on market. These products are designed to help users refill their empty ink cartridges with ink. These products allow printer users to reuse the same ink cartridge and thus can reduce the printer maintenance cost to as low as the cost of ink. Most of these products, however, have failed to obtain consumer confidence. They depend on an injecting method using a syringe like injector, which causes many problems. In fact, the use of the injector requires special skills for adjusting air pressure inside an ink cartridge. Even minor mishandling of the injector could cause ink spills, resulting in messy ink stains all over the places. Also, impurities are prone to come in the ink during the refilling process and may cause poor print quality.

### BRIEF SUMMARY OF THE INVENTION

The present invention provides a liquid refiller for filling liquid in a container. The refiller is comprised of a first mechanism for injecting the liquid into the container and a second mechanism for releasing from the container air compressed resulting from injecting the liquid into the container. The first mechanism may include a case and an injection piston movable inside the case. The second mechanism may include the injection piston and a suction piston movable inside the injection piston.

The injection piston may be urged by a first urging member in such a direction as to move for injecting the liquid into the container. The refiller may also include a first locking mechanism for holding the injection piston against the urging force of the first urging member.

The suction piston may be urged by a second urging member in such a direction as to move for suctioning the compressed air from the container. The refiller may also include a second locking mechanism for holding the suction piston against the urging force of the second urging member. When the liquid injection is completed, the second locking mechanism is automatically released to allow the suction piston to move by means of the second urging member in order to suction the compressed air from the container. The second locking mechanism may be a switch provided in the injection piston and acted upon to release the suction piston when the injection piston comes to an end position where injection of liquid into the container is completed.

The refiller may be used with a base for securing the container thereon. The refiller may also be used with a positioning device for positioning the refiller with respect to the container.

### BRIEF DESCRIPTION OF SEVERAL VIEWS OF THE DRAWINGS

FIG. 1 is a cross-sectional view showing an ink refiller of a preferred embodiment according to the present invention;

FIG. 2A is a cross-sectional view showing a cause used in the ink refiner shown in FIG. 1;

FIG. 2B is a cross-sectional view showing a nozzle provided to the case shown in FIG. 2A;

FIG. 2C is a bottom view showing the case shown in FIG. 2A;

FIG. 2D is a side view showing the case shown in FIG. 2A;

FIG. 3A is a side view showing a case cover used in the refiller shown in FIG. 1;

FIG. 3B is a bottom view showing the case cover shown in FIG. 3A;

FIG. 3C is a cross-sectional view showing the case cover shown in FIG. 3A;

FIG. 4A is a side view showing a locking cap used in the refiller shown in FIG. 1;

FIG. 4B is a bottom view showing the locking cap shown in FIG. 4A;

FIG. 4C is a cross-sectional view showing the locking cap shown in FIG. 4A;

FIG. 5A is a top view showing an injection piston used in the refiller shown in FIG. 1;

FIG. 5B is a side view showing the injection piston shown in FIG. 5A;

FIG. 5C is a bottom view showing the injection piston shown in FIG. 5A;

FIG. 5D is a cross-sectional view showing the injection piston shown in FIG. 5A;

FIG. 5E is a side view showing a switch used in the injection piston;

FIG. 6A is a side view showing a suction piston used in the refiller shown in FIG. 1;

FIG. 6B is a cross-sectional view showing the suction piston shown in FIG. 6A;

FIG. 6C is a bottom view showing the suction piston shown in FIG. 6A;

FIGS. 7A-7F are graphical representations showing refilling operations, using the refiller according to the present invention; and

FIG. 8 is a cross-sectional view showing the refiller according to the present invention in which ink has been injected.

### DETAILED DESCRIPTION OF THE INVENTION

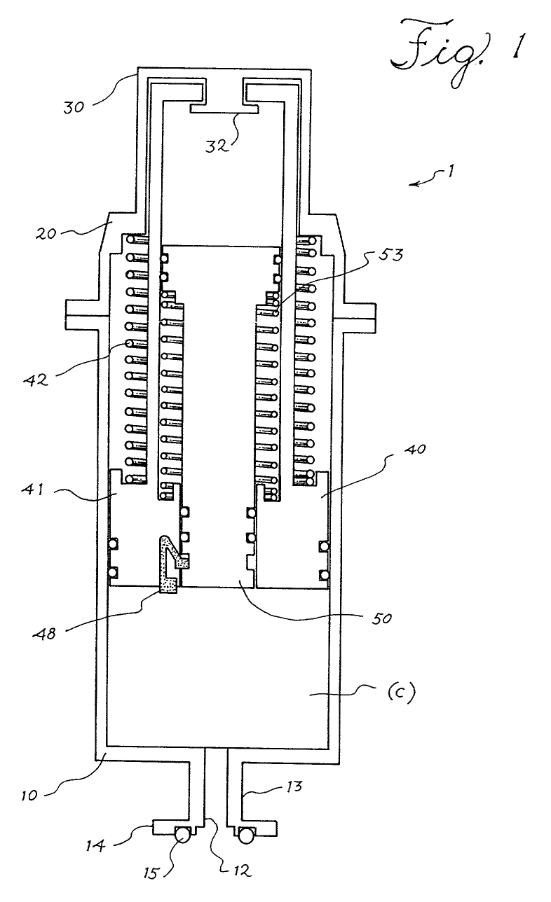

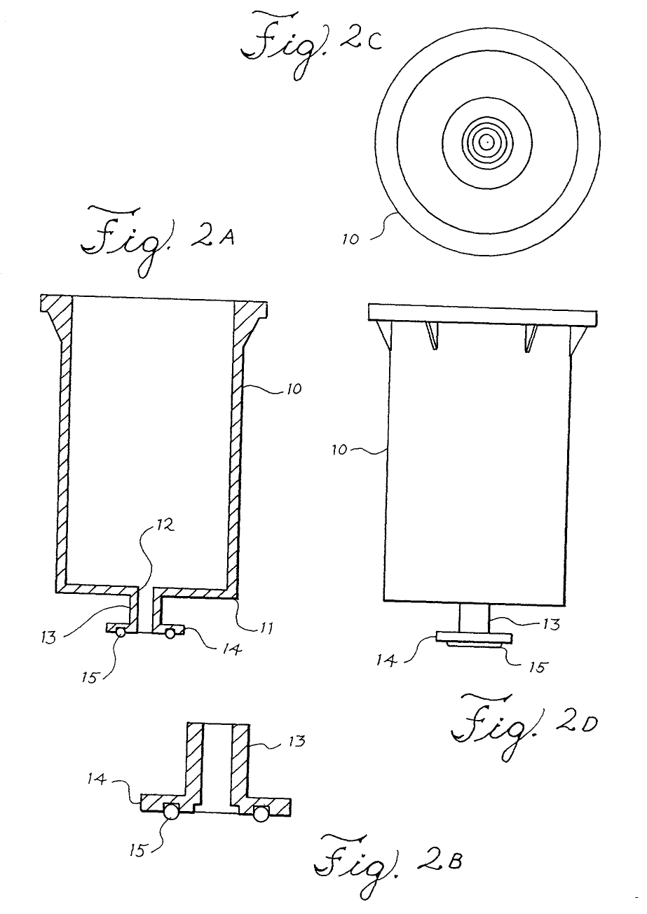

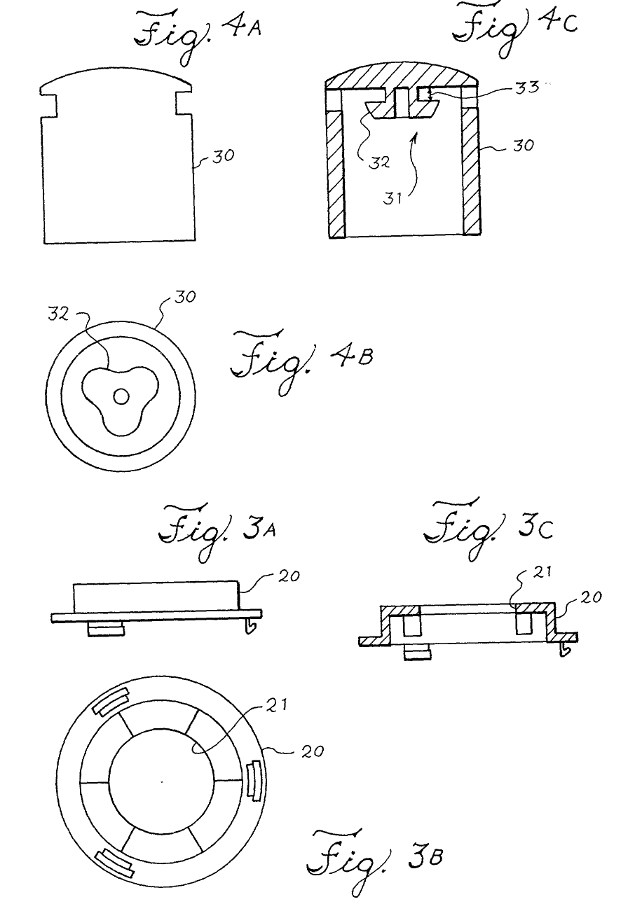

FIG. 1 is a cross-sectional view showing an ink refiller of a preferred embodiment according to the present invention. An ink refiller 1 according to the preferred embodiment includes a hollow cylindrical case 10. As shown in FIGS. 2A-2D, the upper end of the case 10 is open for access to the inside of the case 10, whereas the lower end thereof has a bottom 11 with a hole 12. The hole 12 allows the inside of the case 10 to communicates with the outside through a nozzle 13. The tip of the nozzle 13 is formed with a disk 14 having a circular sealing member 15 attached thereto. The upper end of the case is attached with a case cover 20 having a center hole 21 (FIGS. 3A-3C).

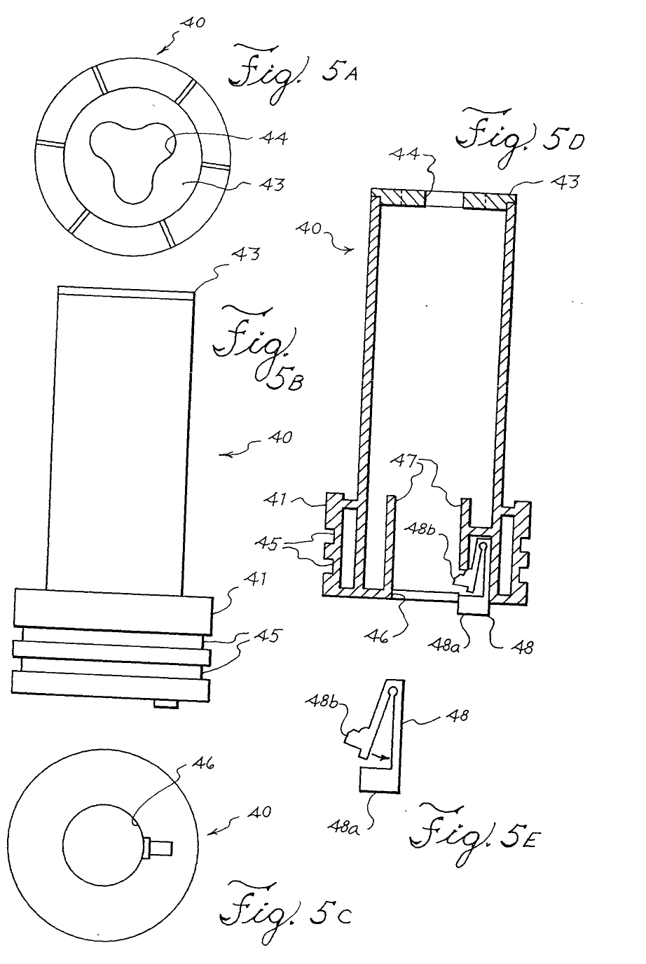

Place on the case cover 20 is a locking cap 30. As shown in FIGS. 4A-4C, the locking cap has a locking mechanism 31 inside the cap. The locking mechanism 31 includes a generally triangular-shaped locking plate 32 that is fixed inside the cap with a gap 33 between itself and the ceiling of the cap.

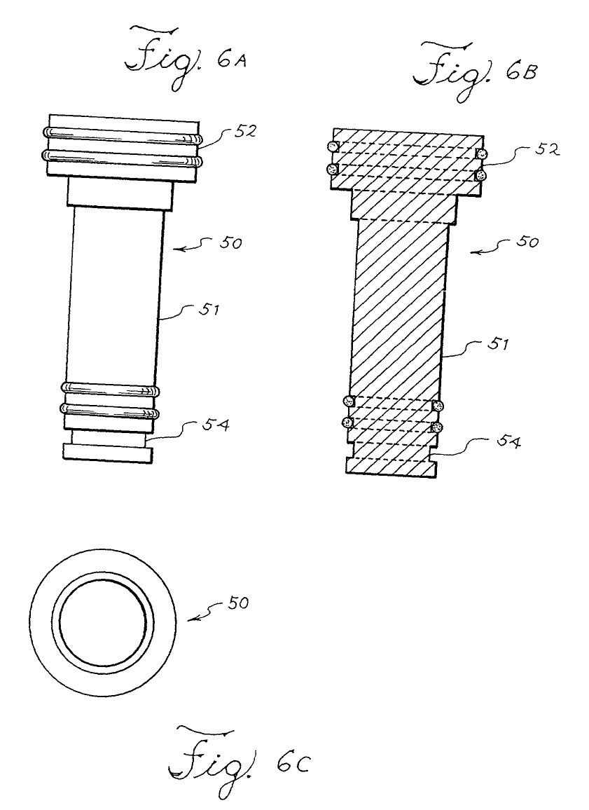

Returning to FIG. 1, the ink refiller 1 has an ink piston 40 slidably inserted in the case 10. The upper portion of the ink piston 40 projects inside the locking cap 30 through the center hole 21 formed in the case cover 20. The lower end portion of the ink piston 40 fits inside the case 10, thereby creating an ink chamber (C) between the lower end of the ink piston and the bottom of the case. In FIG. 1, the ink chamber (C) is filled with ink. The ink piston 40 is generally a hollow cylinder with a large diameter portion 41 that constitutes the lower end portion of the ink piston 40. The ink piston 40 is urged downward by an injection spring 42 that is inserted around the outer surface of the piston 40 between the case cover 20 and the large diameter portion 41. As shown in FIGS. 5A, 5B and 5D, the upper end of the piston 40 is closed with a plate 43 having a hole 44 which is identical in shape to the locking plate 32 provided inside the cap 30. As shown in FIG. 1, the locking plate 32 goes through the hole 44, and by turning the cap 30 with respect to the ink piston 40 to a position where the locking plate 32 and the hole 44 do not agree, the plate 43 of the ink piston 40 is locked in the gap 33, whereby the cap 30 holds the ink piston 40 in the position shown in FIG. 1 against the downward pressure imposed by the injection spring 42. As shown in FIGS. 5B and 5D, the large diameter portion 41 has two lines of circumferential grooves 45 formed thereon. Two sealing members (FIG. 1) are placed in the grooves 45 and tightly close a gap between the outer surface of the large diameter portion 41 and the inner surface of the case 10. The bottom of the piston 40 has a hole 46 contiguous with a cylindrical guide 47 provided inside the large diameter portion 41. Also provided inside the large diameter portion 41 is a switch 48 vertically movable in the large diameter portion. As shown in FIGS. 5D and 5E, the switch 48 has an end 48a projecting from the bottom of the ink piston and another end 48b projecting inside the cylindrical guide 47. When the end 48a is pushed upward, the switch 48 moves up. When the switch 48 moves up, the end 48b retracts from the inside of the guide 47 to the right in FIG. 5E.

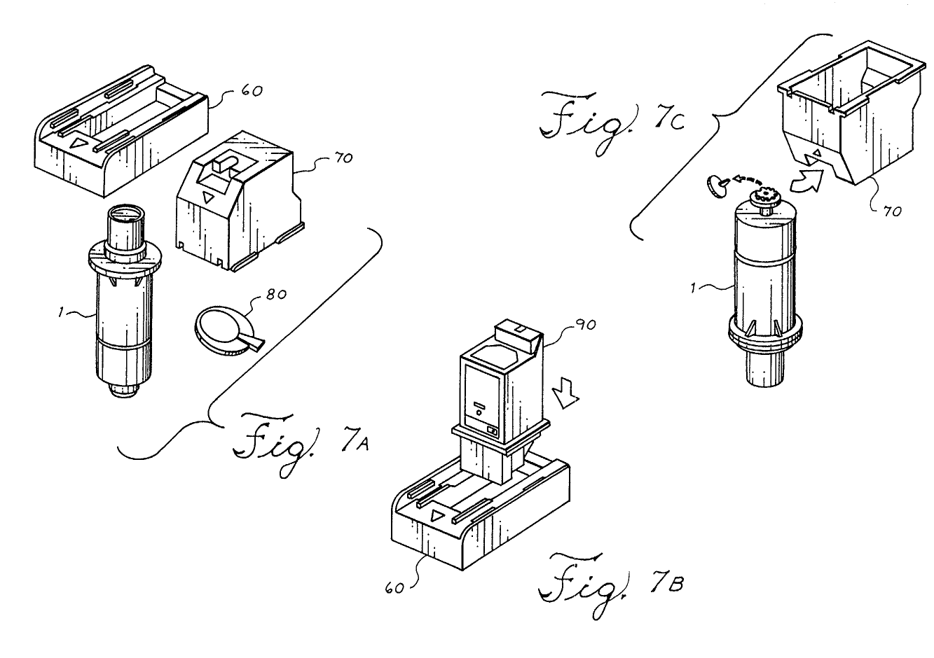

Retuning to FIG. 1, the ink refiner 1 also includes an air piston 50 movably inserted in the ink piston 40. As shown in FIGS. 6A-6C, the air piston 50 has a small diameter portion 51 and a large diameter portion 52. Each of the portions 51 and 52 is formed with a pair of grooves in which sealing members are placed. The large diameter portion 52 fits inside the ink piston 40. The small diameter portion 51 fits inside the cylindrical guide 47. The air piston 50 is pushed upward by a pressure control spring 53. The end of the small diameter portion 51 is formed with another groove 54 with which the end 48b of the switch 48 engages to hold the air piston 50 with respect to the ink piston 40 against the upward pressure from the pressure control spring 53.

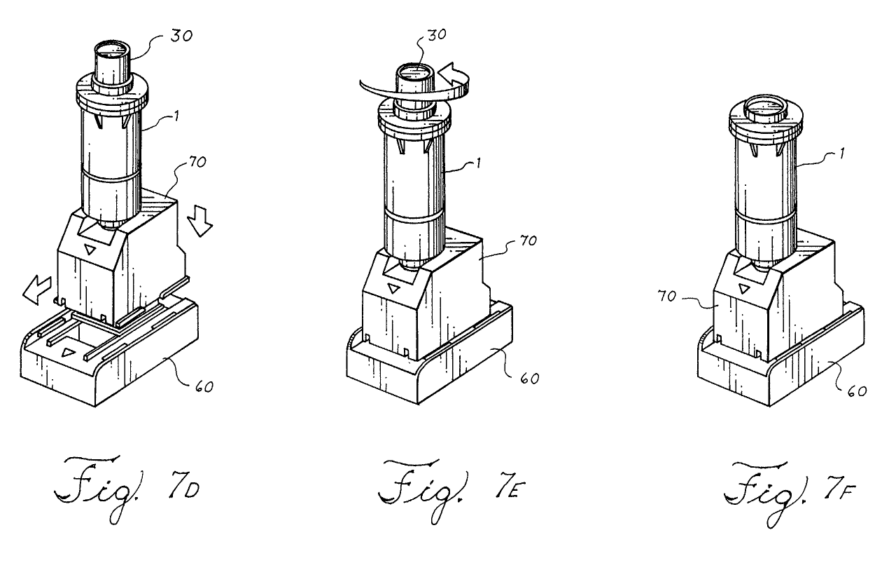

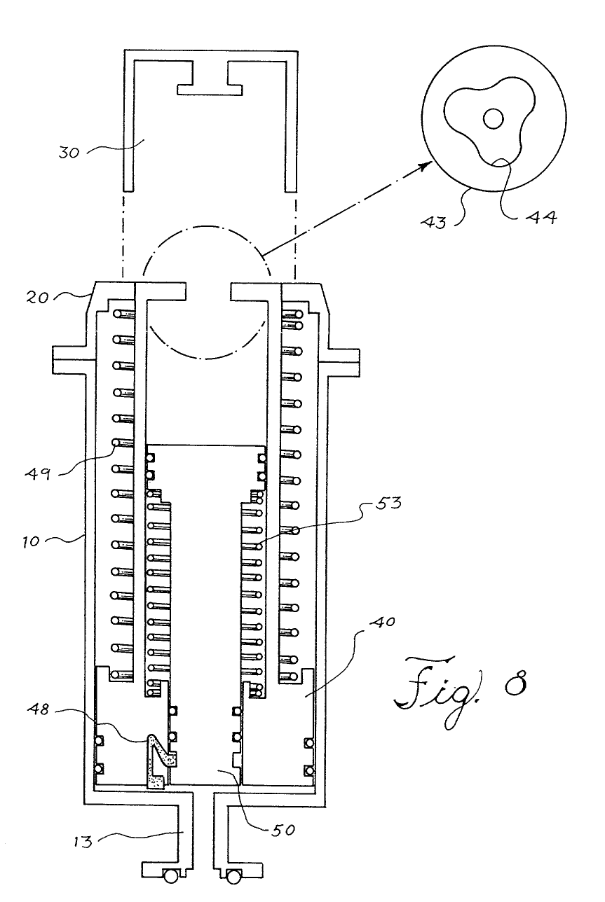

FIGS. 7A-7F show ink refilling operations, using the ink refiller according to the present invention. As shown in FIG. 7A, along with the ink refiller 1, a base 60, a base cover 70 and a spout 80 may be used. In FIG. 7B, an empty printer ink cartridge 90 is placed on the base 60. The spout 80 may be used to clear a passage of the cartridge 90 through which ink is to be injected. The base cover 70 is secured to the refiller 1 as shown in FIG. 7C and then mounted on the base 60 (FIG. 7D) so that the nozzle 13 is aligned tightly with the passage of the cartridge 90. The cap 30 is turned as shown in FIG. 7E. When the locking plate 32 of the cap 30 and the hole 44 of the ink piston 40 come into agreement, the plate 43 of the ink piston 40 is released from the locking mechanism 31. The piston 40 then moves down by the downward pressure from the injection spring 42 and pushes the ink in the chamber (C) into the ink cartridge 90 through the nozzle 13 (FIG. 7F). When the ink piston 40 hits the bottom of the case 10, i.e., the ink in the chamber (C) is all injected in the ink cartridge 90, the end 48a of the switch 48 is pushed upward as shown in FIG. 8. As the switch 48 moves up, the end 48b thereof retracts from the groove 54 of the air piston 50. The air piston 50 then moves up by the upward pressure from the spring 53. After the ink is injected, the air inside the ink cartridge 90 is compressed. In moving up, the air piston 50 suctions out the compressed air inside the ink cartridge 90. The refiller 1, the base 60 and the base cover 70 are dismantled to remove the ink cartridge filled with ink.

What have been described are preferred embodiments of the present invention. The foregoing description is intended to be exemplary and not limiting in nature. Persons skilled in the art will appreciate that various modifications and additions may be made while retaining the novel and advantageous characteristics of the invention and without departing from its spirit. For instance, the present invention has been explained with an embodiment in which a printer ink cartridge is refilled. As persons skilled in the art will appreciate, however, the present invention can be used to refill a container in general. Accordingly, the scope of the invention is defined solely by the appended claims as properly interpreted.

1. A liquid refiller for filling liquid in a container comprising a first mechanism for injecting the liquid into the container and a second mechanism for releasing from the container air compressed resulting from injecting the liquid into the container.

2. A liquid refiller as defined in claim 1, wherein the first mechanism includes a case and an injection piston movable inside the case.

3. A liquid refiller as defined in claim 2, wherein the second mechanism includes the injection piston and a suction piston movable inside the injection piston.

4. A liquid refiller as defined in claim 2, wherein the injection piston is urged by a first urging member in such a direction as to move for injecting the liquid into the container.

5. A liquid refiller as defined in claim 3, further comprising a first locking mechanism for holding the injection piston against the urging force of the first urging member.

6. A liquid refiller as defined in claim 3, wherein the suction piston is urged by a second urging member in such a direction as to move for suctioning the compressed air from the container.

7. A liquid refiller as defined in claim 6, further including a second locking mechanism for holding the suction piston against the urging force of the second urging member.

8. A liquid refiller as defined in claim 7, wherein, when the liquid injection is completed, the second locking mechanism is automatically released to allow the suction piston to move by means of the second urging member in order to suction the compressed air from the container.

9. A liquid refiller as defined in claim 8, wherein the second locking mechanism is a switch provided in the injection piston and is acted upon to release the suction piston when the injection piston comes to an end position where injection of liquid into the container is completed.

10. A liquid refiller as defined in claim 1, further including a base for securing the container thereon.

11. A liquid refiller as defined in claim 1, further including a positioning device for positioning the refiller with respect to the container.

12. A method of refilling liquid into a container, comprising the steps of:
(a) positioning a case having liquid therein with respect to the container
(b) injecting the liquid into the container, using an injection piston movable inside the case; and
(b) suctioning compressed air from the container, using a suction piston movable inside the injection piston.

13. A method as defined in claim 12, wherein the injection piston is urged by a first urging member in such a direction as to move for injecting the liquid into the container.

14. A method as defined in claim 13, wherein the injection piston is held against the urging force of the first urging member until injection is initiated.

15. A method as defined in claim 12, wherein the suction piston is urged by a second urging member in such a direction as to move for suctioning the compressed air from the container.

16. A method as defined in claim 15, further including the suction piston is held against the urging force of the second urging member until injection of the liquid is completed.

17. A method as defined in claim 16, wherein, when the liquid injection is completed, the suction piston is automatically released to move by means of the second urging member in order to suction the compressed air from the container.
